(19) United States
(12) Patent Application Publication
(10) Pub. No.: US 2015/0339952 A1
(43) Pub. Date: Nov. 26, 2015

(54) METHOD AND SYSTEM FOR USING LOCATION SERVICES TO TEACH CONCEPTS

(71) Applicant: NIRIT GLAZER, Ann Arbor, MI (US)

(72) Inventor: NIRIT GLAZER, Ann Arbor, MI (US)

(21) Appl. No.: 14/720,530

(22) Filed: May 22, 2015

Related U.S. Application Data
(60) Provisional application No. 62/002,854, filed on May 24, 2014.

(51) Int. Cl. G09B 23/24; G09B 5/00

(52) U.S. Cl. CPC G09B 23/24; G09B 5/00

(57) ABSTRACT

A learning system includes a server configured to associate mobile devices with participants such that locations of the participants serve as a life-size model of a learning activity. The learning system also includes a server configured to track the locations of the mobile devices to determine progress of the participants in performing the learning activity. The learning system also includes a display of the locations of the mobile devices on a screen visible to the participants to provide feedback to the participants regarding the progress in performing the learning activity. A mobile device for use in the learning system is also disclosed.

### CROSS-REFERENCE TO RELATED APPLICATIONS

This application claims the benefit of U.S. Provisional Application No. 62/002,854, filed May 24, 2014, the disclosure of which is incorporated in its entirety by reference herein.

### BACKGROUND OF THE INVENTION

1. Field of the Invention

The present disclosure relates to a method and system for using location services to teach concepts.

2. Background Art

Teachers are typically required to instruct large numbers of participants at one time. Teachers are required to manage activities in a classroom and further engage participants in an active learning process, in order to teach the required lesson. In an example of such activities, participants are engaged in an active learning process by performing tasks within a life-size model. These activities may teach core principles and concepts in science that are central to explain scientific phenomena, and are fundamental to understanding other scientific concepts.

For example, a chemical reaction is to one of the central big ideas in chemistry literacy. At the fundamental level, a chemical reaction is a phenomenon in which substances are changed into completely different substances. In this phenomenon, atoms are rearranged to form new compounds having a new set of properties, while the mass is preserved. After the middle-school level, the definition of a chemical reaction would be more detailed and would include such aspects as reverse reactions. This concept refers to a latent idea which may be only in the minds of people. It can include more than one sub-concept and may be represented in a concept map.

A construct is a large concept. It is constructed from several concepts and may include one or more sub-constructs. Like concepts, a construct may be represented by a map, namely, a construct map. For example, a construct can be a “chemical reaction” which includes three sub-constructs, namely, the change of properties, the rearrangement of atoms, and the conservation of mass.

A concept map refers to a logical or visual representation that displays suggested relationships between concepts and/or ideas and/or information. A model refers to anything used in any way to understand better or to predict concepts and/or phenomena. A construct map refers to a graphical representation of a consecutive continuum in the understanding of a specific construct. The map displays hierarchical levels of participant understanding, progressing from lesser understanding towards more sophisticated understanding of the construct.

A curriculum refers to all the aspects of the instruction through which participants experience a certain course. This includes the content knowledge and the skills that the participants are expected to learn, the lesson plans, the materials (e.g., textbooks, audio, video, online sources, models) provided, the pedagogical guidelines, the learning goals, the learning performances, the sequences for teaching the ideas, the educational theories, and how these theories are embedded into class activities.

Active learning is a process wherein participants engage in learning activities. It is in contrast to passive learning wherein participants passively receive information from an instructor.

Various systems have been developed to improve participant learning. For example, participant response systems are commonly used to solicit responses from participants during classes. Such systems also provide feedback for the teacher regarding the level of understanding of the current thought concept before moving to the next concept. Another example is an assessment feedback system in which a participant receives personalized feedback on misconceptions regarding certain concepts.

Common methods of managing classroom activities consist of distributing worksheets to participants before each activity and collecting them for evaluation at the end of the activity for evaluation. These methods provide little-to-no feedback to the participants or interaction with classmates while performing the activity. The lack of instant feedback causes participants that are doing poorly in a task to become frustrated and to lose interest in the activity. These participants often disturb other participants and, many times, cause the instructor to lose control over the activity. As a result, only a selected few concepts can be taught by means of group classroom activities. Accordingly, participants fail to utilize active learning, which is an important learning method.

### SUMMARY OF THE INVENTION

A learning system includes an application server configured to associate mobile devices with participants such that locations of the participants serve as a life-size model of a learning activity. The learning system also includes an application server configured to track the locations of the mobile devices to determine progress of the participants in performing the learning activity. The learning system also includes a display of the locations of the mobile devices on a screen visible to the participants to provide feedback to the participants regarding the progress in performing the learning activity.

An apparatus includes a mobile device configured to receive, from an application server, information descriptive of an assignment of a participant associated with the mobile device to an element of a life-size model of a learning activity; display the information to the participant to inform the participant of the element of the life-size model to which the participant is assigned; and send, to a real-time location server, information indicative of a current location of the mobile device to cause the server to determine progress of the participant in performing the learning activity.

In at least one embodiment, a method includes associating mobile devices with participants and with elements of a learning activity, such that locations of the participants serve as a life-size model of the learning activity; periodically tracking the locations of the mobile devices to determine progress of the participants in performing the learning activity; and displaying the locations of the mobile devices on a screen visible to the participants to provide feedback to the participants regarding the progress in performing the learning activity.

Embodiments according to the present disclosure provide a number of advantages. For example, the present disclosure is expected to engage participants in the active learning activity while providing feedback to the participants. The present disclosure is expected to provide participants with real-time evaluations of their progress to ensure the proper knowledge is gained.

### BRIEF DESCRIPTION OF THE DRAWINGS

FIG. 1 is a system view of a representative application for a method and learning system for using location services to teach concepts according to one embodiment of the present disclosure;

FIG. 2 is a system view of a 2^{nd} representative application for a method and learning system including a display for using location services to teach concepts according to one embodiment of the present disclosure;

FIG. 3 is a system view of a 3^{rd} representative application for a method and learning system including a display and at least partial peer to peer location tracking for using location services to teach concepts according to one embodiment of the present disclosure;

FIG. 4 is a system view of a 4^{th} representative application for a method and learning system including mobile device location tracking for using location services to teach concepts according to one embodiment of the present disclosure;

FIG. 5 is a system view of a 5^{th} representative application for a method and learning system including a display and different types of mobile devices for using location services to teach concepts according to one embodiment of the present disclosure.

FIG. 6 is a flow chart of a method for using location services to teach concepts;

FIG. 7 is a flow chart of a 2^{nd} method for using location services to teach concepts;

FIG. 8 is a flow chart of a 3^{rd} method for using location services to teach concepts;

FIG. 9 illustrates a representative classroom application of a method and learning system for using location services to teach concepts;

FIG. 10 illustrates a representative display of a method and learning system for using location services to teach concepts;

FIG. 11 illustrates a representative chemical learning activity for a method and learning system using location services to teach concepts;

FIG. 12 illustrates a 2^{nd} representative display at the beginning of a chemical reaction learning activity;

FIG. 13 illustrates a 3^{rd} representative display at the successful completion of the chemical reaction learning activity;

FIG. 14 illustrates a 4^{th} representative display at the completion of the chemical reaction learning activity, showing a variety of misconceptions;

FIG. 15 illustrates instructions and feedback to the participants on their mobile devices;

FIG. 16 illustrates the potential uses of aggregated activity data beyond the classroom setting;

FIG. 17 illustrates the potential analytics that may be applied to smart data; and

FIG. 18 is an alternative system view of a representative application for a method and learning system.

### DETAILED DESCRIPTION OF THE PREFERRED EMBODIMENT(S)

As those of ordinary skill in the art may understand, various features of the present invention as illustrated and described with reference to any one of the figures may be combined with features illustrated in one or more other figures to produce embodiments of the present disclosure that are not explicitly illustrated or described. The combinations of features illustrated provide representative embodiments for typical applications. However, various combinations and modifications of the features consistent with the teachings of the present disclosure may be desired for particular applications or implementations.

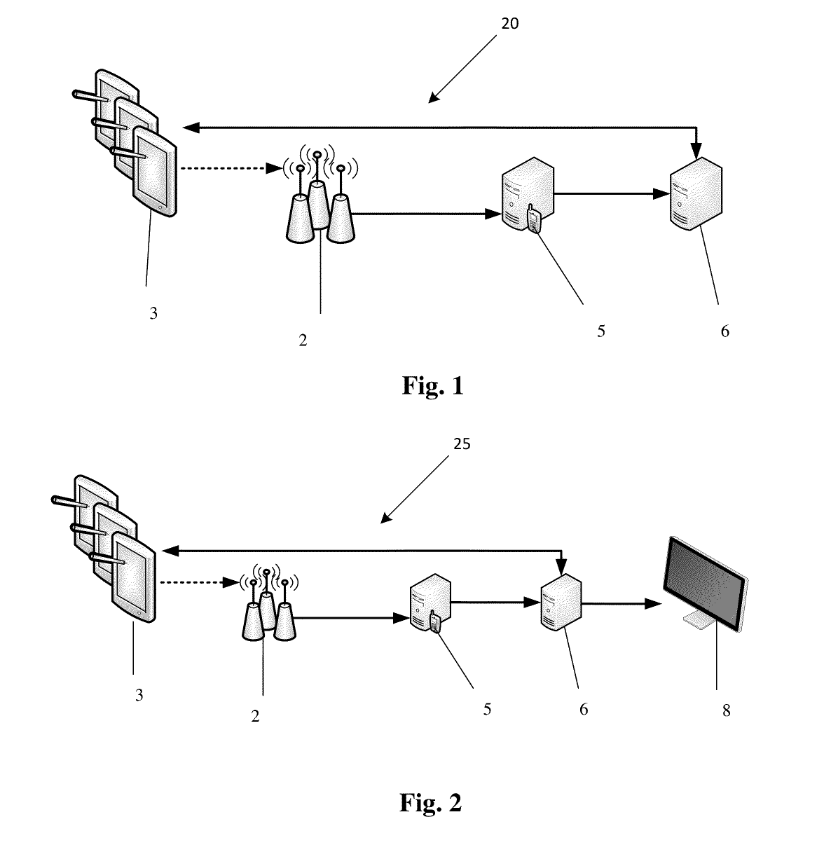

Referring now to FIG. 1, a learning system 20 includes an application server 6. The application server 6 may associate mobile devices 3 with participants and use those participants to create a life-size model of a learning activity. In many cases the participants may be students in a school or classroom setting, but in other examples the participants may include firepersons, police officers, medical or military personnel, or any other participant of a location based training curriculum. The application server 6 may also receive location data from the real-time location server 5. The real-time location server 5 may locate the mobile devices 3 in the learning environment using a plurality of location sensors 2. Using the received location data, the application server 6 may send information, related to the learning activity, to the mobile devices 3 for display, providing feedback to the participants regarding the progress in performing the learning activity.

In at least one embodiment, the application server 6 and real-time location server 5 are located on the same server. The server is configured to associate mobile devices with participants such that the locations of the participants serve as a life-size model of a learning activity. The server is configured to track the locations of the mobile devices 3 to determine progress of the participants in performing the learning activity. The server is also configured to provide this information to a display, providing feedback to the participants regarding the progress in performing the learning activity.

The application server 6 may associate mobile devices 3 with participants such that locations of the participants serve as a life-size model of a learning activity. The application server 6 may also track the locations of the mobile devices 3 to determine progress of the participants in performing the learning activity. The application server 6 may also send display mobile device 3 data to be displayed on a screen visible to the participants to provide feedback to the participants regarding the progress in performing the learning activity.

The application server 6 may be configured to identify a location adjustment to be made by one of the participants, possibly a misplaced atom in a molecule, to coach the participants on the proper way to carry out the activity. The application server 6 could place an icon on the display with the correct location or arrows directing the proper location. The application server 6 could send information to the respective mobile device that is descriptive of the required adjustment.

The application server 6 may contain software for numerous learning activities. The application server 6 may also contain a database or data store 10 for data aggregation related to the learning activities and the participants' progress. The application server 6 may contain processes for determining user associations, connected status of users, time to answer questions correctly, or provided additional questions to ensure comprehension.

As shown in FIG. 1, the mobile devices 3, location sensors 2, real-time location server 5, and application server 6 may all communicate via a communications network. The communications network can be wired, wireless, or both.

As shown in FIG. 1, the mobile device 3 is a tablet computer. The mobile device 3 may be configured to communicate with the application server 6. The tablet computer may also communicate with the location sensors 2, real-time location server 5, or other mobile devices. The participants may provide an indication of completion to the application server 6 by actuating a button or selecting an option on the mobile device 3.

Examples of mobile devices may include: cell phones, tablets laptop computers, personal digital assistants, radio-frequency identification (RFID) tags, smartwatches, or any other device configured to be assigned to users and be located by a location sensor 2 as described below. Mobile devices may include a display for notifying the user of progress in the learning activity, or the mobile devices may only provide location features to enable the application server 6 to associate the mobile devices with participants and track their locations.

As shown in FIG. 1, a location sensor 2 provides location information to a real-time location server 5. The location sensor 2 can use any electromagnetic or other physical mediums to provide location data to the real-time location server 5. The location sensor 2 uses Wi-Fi wireless networking technology signal strength indication (RSSI) signals to gather positional data from each mobile device. In another embodiment the location sensor 2 may use GPS or other similar protocols to triangulate position data. It is understood that the use of any medium or location protocol presently known or unknown may be used to gather location information. The location sensor 2 or location device 2 may be part of the real-time location server 5 or a separate device.

It is also understood that the location sensor 2 may serve as anchors whereby the mobile devices 3 send the real-time location server 5 information related to the mobile devices' position.

The real-time location server 5 receives location data from the location sensor 2 and determines the location of the mobile devices 3. Numerous location methods are available to determine the position of the mobile devices 3. These methods include range-based algorithms, which utilize distance or angle measurements, and range-free algorithms that are less hardware intensive. Some of these algorithms include: radio frequency and ultrasound time-of-flight (TOF), global positioning system (GPS), time difference of arrival (TDOA), RSSI, angle of arrival (AOA), centroid or center of gravity (COG), DV-Hop, multilateration, approximated point in triangle (APIT), SeRLoc, probability grid, multi-dimensional scaling, LightHouse, SpotLight, scene analysis, optical methods, microelectromechanical systems, pedestrian dead-reckoning, near field communication (NFC), or any other location protocol or algorithm that may be used to determine the position of the mobile devices 3 that could locate the mobile device 3. In many examples, these approaches may acquire the distance from the observed object to at least two reference points to determine the object's location. One or more approaches for device location may be applied using triangulation, reverse nearest neighbor, or a Voronoi diagram. These results may be improved by using anchors or a combination of methods.

The application server 6 may locate the mobile devices 3 using relative locations throughout a grid or absolute predetermined locations based on a predetermined map of the learning area. The application server 6 may be populated with a predetermined coordinate system or grid to place mobile devices 3 on a map of the teaching area. The application server 6 may also compare relative locations between the mobile devices 3 to determine if they meet the learning activity's criteria.

For example, using the relative method, the application server 6 may first assign pseudo-random elements to each of the mobile devices 3. The application server 6 may then require, at stage two, that all participants are gathered in one area of the room. The application server could determine that the location of the participants was near one side of the room via the location anchors. The application server 6 could use intelligence to assign that area as one section of the room. The application server may also choose one mobile device 3 to serve as the center of the relative coordinate system. During stage three, the participants may spread throughout the room. The application server 6 could recognize that the activity has started using statistical methods based on the participant's location. The application server 6 may then determine the relative location of the participants as forming a molecule, based on the proximity of the assigned elements. The proximity may be determined using a distance calculation method, i.e. finding the distance and angle between two points. The first student could be selected as the (0,0) coordinate, and then distances and angles to the other atoms in the molecule could be calculated. The application server 6 could then provide feedback to the participants related to their progress.

For example, using the absolute location method, the learning activity may first assign pseudo-random elements to each of the mobile devices. The application server 6 may then require, at stage two, that all participants are gathered in one area of the room. The application server 6 may determine that the students have gathered in a pre-mapped area of the room based on the location data from the location server. During stage three, the participants may spread throughout the room. The application server 6 could recognize that the activity has started using statistical methods relevant to the participant's location. The application server 6 may then determine completion of the activity because participants have been assigned to form molecules in predetermined locations in the room. The application server 6 could then compare the absolute locations of the participants to pre-determined acceptance criteria. The application server 6 could then provide feedback to the participants related to their progress.

iBeacon™ may be used to locate users within a pre-determined space. The iBeacon™ technology is based on radio-frequency (RF) received signal strength indicators (RSSI). It broadcasts the unique ID of the beacon using Bluetooth Low Energy (BLE) Technology. The iBeacon™ technology divides the space around the transmitter into 4 regions according to the received signal strength: immediate (<1 m), near (1-3 m), far (>3 m) and unknown (no signal).

The learning activity may include participants walk between physical stations, each representing a concept. In each station, participants perform tasks. Depending on the success level in the performance of a task, each participant may be directed to another station to learn either a pre-required concept or a following concept.

In at least one different embodiment of the learning activity, participants represent elements in a scientific phenomenon. The participants are moved in the classroom according to the timeline of the elements in the phenomenon. Such a phenomenon may be a chemical reaction, a mass conservation, a freezing or heating process, a deoxyribonucleic acid (DNA) replication, or an infection process.

In at least one other embodiment, the learning activity aims to assist participants that are struggling to understand, among other matters, the model of the particulate nature of matter, the distinction and relation between representation levels, the interactive aspect of the process (the additive misconception), or the complete change of matter properties into a new substance. The participants may also struggle to understand chemical reactions as a dynamic process, and to comprehend fully the conservation of mass principle.

Engaging in modeling scientific phenomena may improve the understanding of such phenomena. In at least one embodiment such modeling may be achieved by integrating wearable technologies in classroom activities; for example, smartwatches can be used to simulate chemical bonding in a process of bond-breaking or bond-formation during a selected chemical reaction.

The learning activity may require each participant to wear a mobile device 3, such as a smartwatch, and may be assigned, through the mobile device 3, to be an atom. A display 8, such as a big screen television, may project the reactants of a chemical reaction, and the participants may to move around in the room until they find other atoms (participants) with whom to bond. Once application server 6 identifies based on the mobile device 3 locations that the atom or atoms are bonded in a correct formation, the mobile devices 3 may signal the participants (e.g., vibrate), thereby simulating a chemical bond-formation. Such system may accordingly provide an instant feedback regarding the correctness of the bond-formation, and may issue an alert in case any corrections are needed to be made. For example, an alert may be issued when participants mistakenly create a water molecule (H₂O) with the Oxygen appearing first in a line next to the two Hydrogen atoms (i.e., O—H—H), rather than between the two Hydrogen atoms (i.e., H—O—H).

Participants would then be directed, again on the display 8, such as a big screen or mobile device 3, to form the products while simulating bond-breaking and bond-creation. To yield the products, participants would not only need to form the correct products, but would also need to assure that they start with enough atoms in the reactant side.

These participants would thereby be engaged in modeling the mass conservation principle, i.e., in making sure that they start and end the reaction with the same number and type of atoms (balancing equations). Further, the activity engages participants with modeling other aspects of the scientific phenomena, such as (1) the interactive aspect of chemical reactions, and (2) the dynamic process of chemical reactions. Even further, the instant feedbacks would be embedded in the activity in order to help participants make a better connection between the three levels of representation of a chemical phenomenon, namely the macroscopic, the microscopic, and the symbolic levels.

Similar activities may be used to teach other topics, such as limiting reactants, the law of gases, the structure of molecules, reaction rates, phase changes, thermodynamic phenomena, random distribution, or infection processes.

The activity may be displayed on a display 8, such as a large television, monitor, or projector and may be recorded for further analysis. For example, the further analysis may initially involve tracking the times and number of attempts by participants to form the correct formation of a chemical formula. It may also involve tracking the mistakes that are being made by participants. The analysis may be done by the application server 6. The analysis may then involve tracking the times and the number of attempts of having a sufficient amount of reactants in order to yield the correct amount of products, i.e., in order to reach a balanced equation. An indoor location technology may utilize RF emission from mobile devices, such as Wi-Fi and Bluetooth, to identify the location of the device in relation to neighboring devices. Such technology is used to track the locations of participants in the classroom during the activities in order to assess their advancement. It may also be used to identify “bottlenecks” that hinder participant success, i.e., threshold concepts, or connections between concepts, that are pre-required knowledge. The location of the participants may also be used to detect sequences of learning for different clusters of participants.

Referring now to FIG. 2, the learning system 25 includes an application server 6. The application server 6 is configured to associate mobile devices 3 with participants and using those participants to create a life-size model of a learning activity. The application server 6 is configured to receive location data from the real-time location server 5. The application server 6 is also configured to send the information to the display 8 in order to display the locations of the mobile devices 3 to provide feedback to the participants regarding the progress in performing the learning activity.

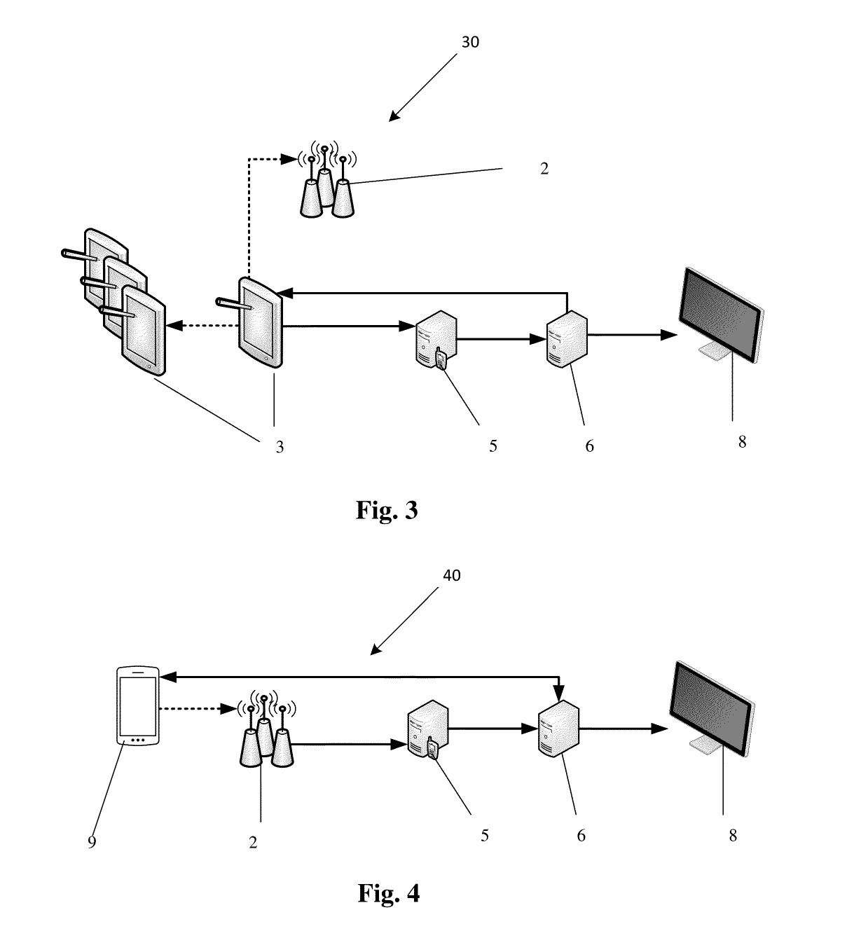

Referring now to FIG. 3, the learning system 30 includes an application server 6. The application server 6 is configured to associate mobile devices 3 with participants and use those participants to create a life-size model of a learning activity. The application server 6 is configured to receive location data from the real-time location server 5. Each mobile device 3 may be configured to determine a relative location of the mobile device 3 with respect to the location sensor 2 or access point 2 and with the other mobile devices 3. The mobile devices 3 may be in communication with the real-time location server 5 in order to communicate these locations. The application server 6 is also configured to send the information to the display 8 in order to display the locations of the mobile devices 3 to provide feedback to the participants regarding the progress in performing the learning activity.

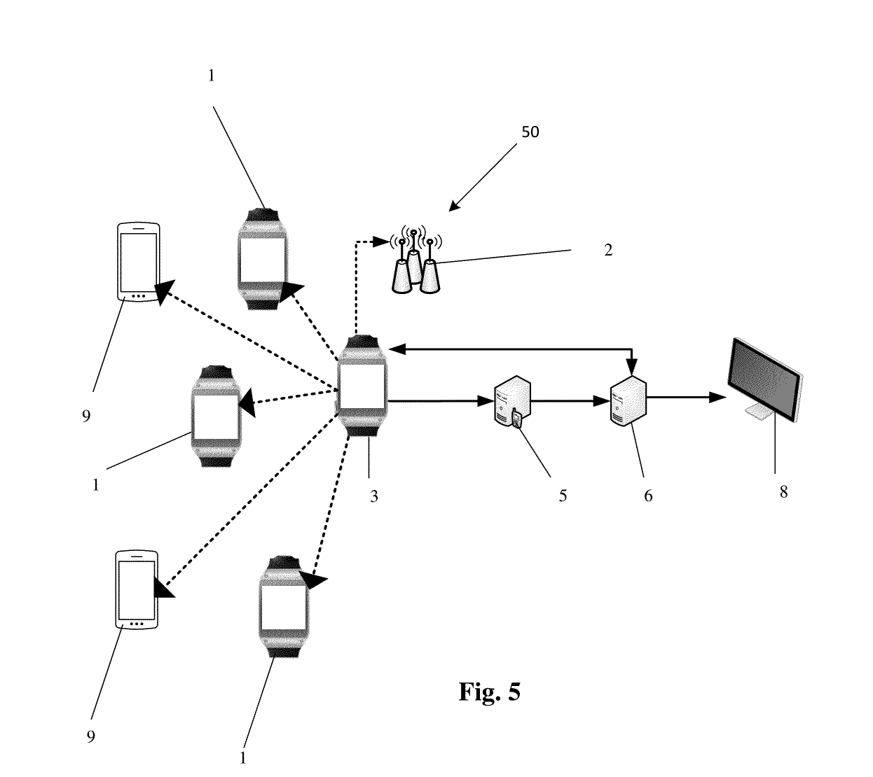

Referring now to FIG. 4, the learning system 40 includes an application server 6. The application server 6 is configured to associate smartphones 9 or smartwatches 1 with participants and use those participants to create a life-size model of a learning activity. The application server 6 is configured to receive location data from the real-time location server 5. The application server 6 is also configured to send the information to the display 8 in order to display the locations of the mobile devices 3 to provide feedback to the participants regarding the progress in performing the learning activity.

Referring now to FIG. 5, the learning system 50 includes an application server 6. The application server 6 is configured to associate smartphones 9 or smartwatches 1 with participants and using those participants to create a life-size model of a learning activity. The application server 6 is configured to receive location data from the real-time location server 5. The smartphones 9 or smartwatches 1 may be configured to determine its relative location with respect to the location sensor 2 or access point 2 and with the other smartphones 9 or smartwatches 1. The mobile devices 3 may be in communication with the real-time location server 5 in order to communicate these locations. The application server 6 is also configured to send the information to the display 8 in order to display the locations of the smartphones 9 or smartwatches 1 to provide feedback to the participants regarding the progress in performing the learning activity.

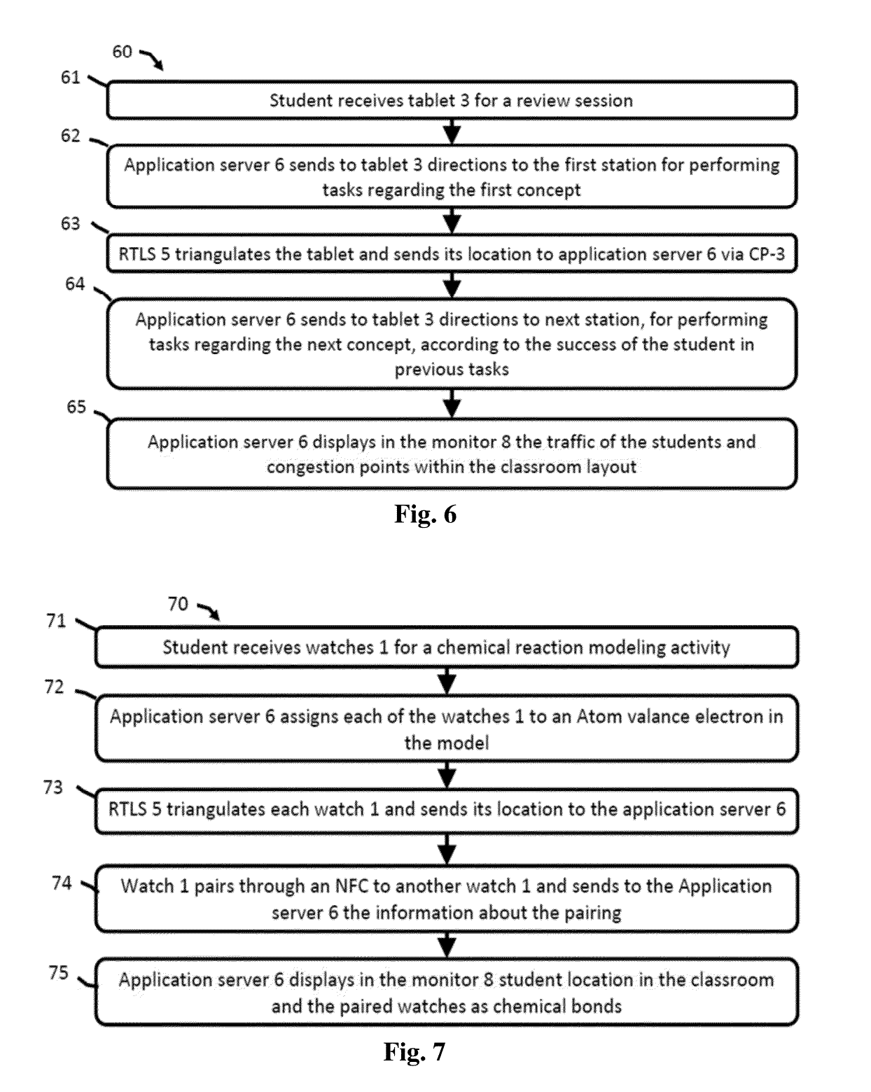

According to FIG. 6, a method 60 is depicted whereby a learning activity is conducted. The method is conducted by giving each participant a mobile device 3, such as a tablet, as specified in step 61. In step 62, the application server 6 sends the tablet directions for performing tasks associated with the first station or first concept. In step 63, the real-time location server 5 triangulates the location of the mobile device 3, such as a tablet, and sends its location to the application server 6. As specified above, other algorithms may be used to locate the tablet. In step 64, the application server sends the mobile device 3, such as a tablet, directions to the next station, for performing tasks regarding the next concept, according to the success of the participant in previous tasks. In step 65, the application server displays on the display 8, such as a monitor, the results of the participant and information related to congestion points within the classroom layout.

According to FIG. 7, a method 70 is depicted whereby a chemical bonding learning activity is conducted. As shown in step 71, a participant receives mobile device 3, such as a smartwatch 1, for a chemical bonding modeling activity. In step 72, an application server 6 assigns each of the smartwatches 1 as an atom. In step 73, the real-time location server 5 triangulates each smartwatch 1 and sends its location to the application server 6. As specified above, other algorithms may be used to locate the smartwatch 1. In step 74, the smartwatch 1 may also pair through near field communication (NFC) to other smartwatches and send additional location data to the application server 6 about the chemical bond and location of the smartwatches. In step 75, the application server displays on the display 8, such as a monitor, the participants' location in the classroom and the paired smartwatches as chemical bonds. Each of the location algorithms, triangulation or NFC pairing, can be replaced with different location algorithms as specified above. The algorithms can be used in tandem or individually to perform the steps of this method.

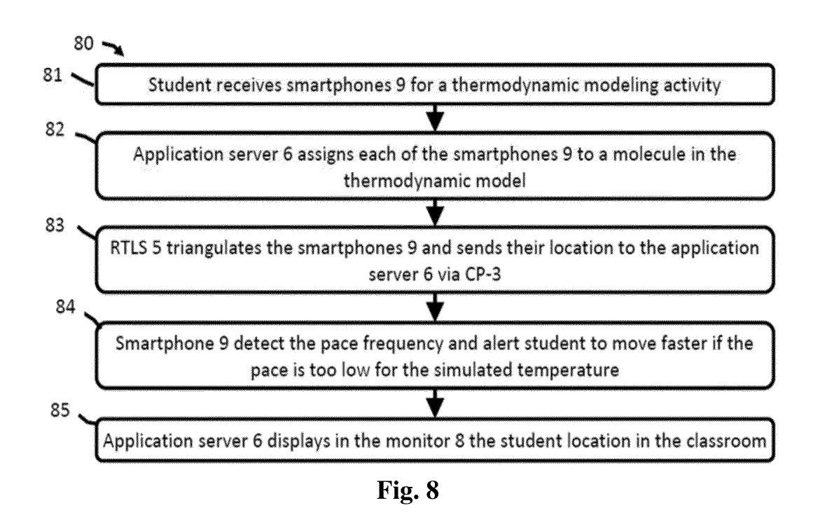

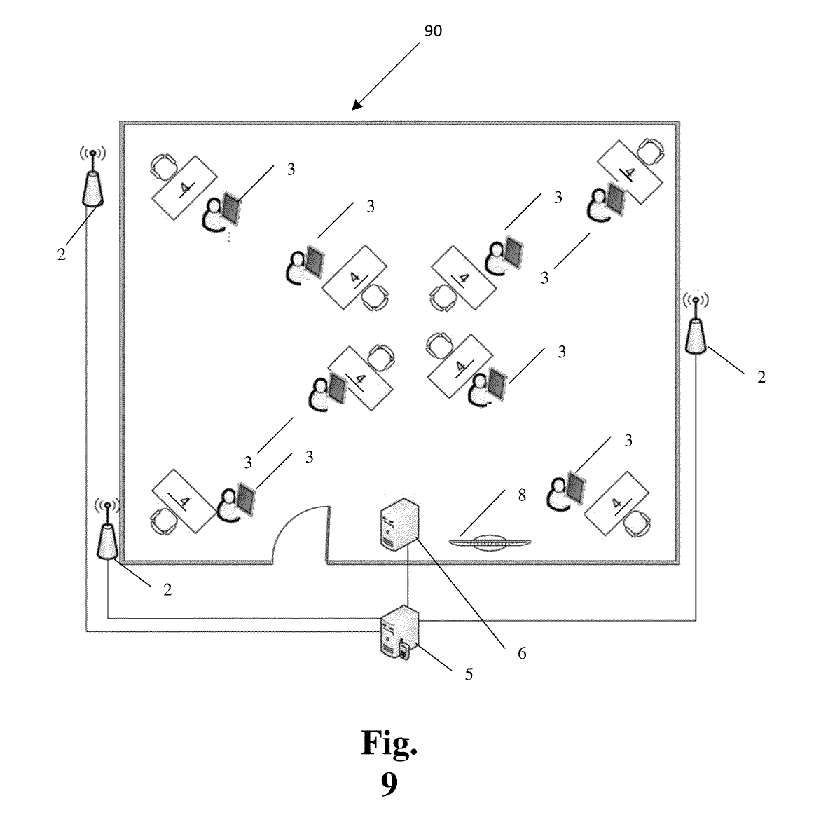

According to FIG. 8, a method 80 is depicted whereby a thermodynamic modeling learning activity is conducted. In step 81, a participant receives a smartphone 9 for a thermodynamic modeling activity. In step 82, an application server 6 assigns each of the smartphones 9 to a molecule in the thermodynamic model. In step 83, a real-time location server 5 triangulates the smartphones 9 and sends locations to the application server 6. In step 84, the smartphone 9 detects the pace frequency of the participant and alerts the participant to move faster if the pace is too low for the simulated temperature. In step 85, the application server 6 displays on the display 8, such as a monitor the participants' location in the classroom and results of the exercise.

Although classroom exercises are discussed in the aforementioned figures, the learning activities my take place outside or in a non-traditional learning environment. The method and learning system for using location services to teach concepts can be applied to any curriculum including: fireperson training, police officer training, medical training, military training, or any other location based training curriculum.

Additional examples of activities could include spelling activities, mathematical activities, or scientific activities.

During spelling activities, each participant takes the role of a letter. As a group, the participants create words, sentences, or other language illustrations. Similar to the chemical reaction example above, the letters are displayed, and the participants need to stand in the right location and between the correct letters in order to move on to the next illustration.

During mathematical activities, each participant is part of the mathematical puzzle. For example, each participant is assigned a number and the participant needs to locate themselves near the correct participant to solve an arithmetic problem.

During other mathematical activities, matching games could also be played. For example, one participant is a letter and another participant is a picture of a plant or animal that starts with that letter.

During scientific activities, mobile devices are used to engage participants in modeling a phase change phenomenon (e.g. transforming from a solid to liquid to gas). Participants are grouped together in one side of the classroom. Each participant is assigned the role of a water molecule. The system instructs the participants to alter their movement level (e.g. jumping, running, spreading out in the class) in accordance with the state of matter they are representing.

Similar activities may be used to teach other scientific concepts including medical phenomena, such as limiting reactants, the law of gases, reaction rates, thermodynamic phenomena, elasticity and plasticity of matter, asthma, allergies, or spread of infectious disease.

For instance, during the spread of infectious disease activity participants are infected, vaccinated, or immunized to a given disease. The infected participant moves around the classroom in an effort to make other participants sick. The exercise is recorded, and data from the exercise may be aggregated. The aggregated data may lead to follow up activities such as posing “what if” questions for different scenarios or starting the activity with a different percentage of participants vaccinated, infected, or immunized. The different scenarios could also include illustrating the transfer rate of other diseases.

While many activities are related to school age children, this teaching learning system and method may be used to teach adults in a military, fire, police, medical environment, or any other location based training curriculum.

Referring to FIG. 9, a classroom is used to teach concepts using location services. FIG. 9 depicts a system 90 and method to teach a concept at different stations using a concept map and location services. A plurality of workstations 4 representing concepts are distributed throughout the classroom. Participants with mobile devices 3 are able to move from station to station, performing both learning and assessment tasks to verify their understanding of the concept.

The real-time location server 5 locates the mobile devices 3 carried by the participants and reports their locations to the application server 6. The application server 6 may verify the success level of the participants in the tasks and may direct the participants to the next station to learn a new concept or to a previous station to practice a previous concept. A big display 8 may display, throughout the activity, the traffic of participants in the classroom and the congestion points within the classroom layout.

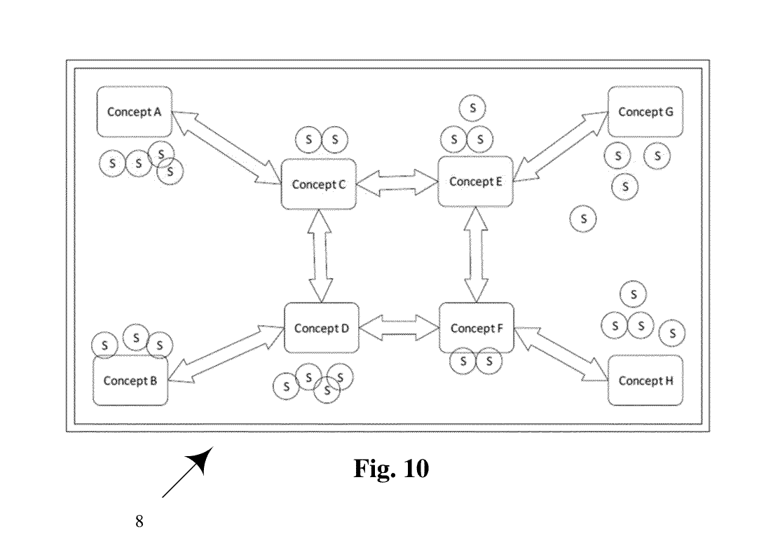

FIG. 10 depicts the display 8 used during the learning activity. The display 8 illustrates the traffic of the participants in the classroom and the congestion points within the classroom layout as described above.

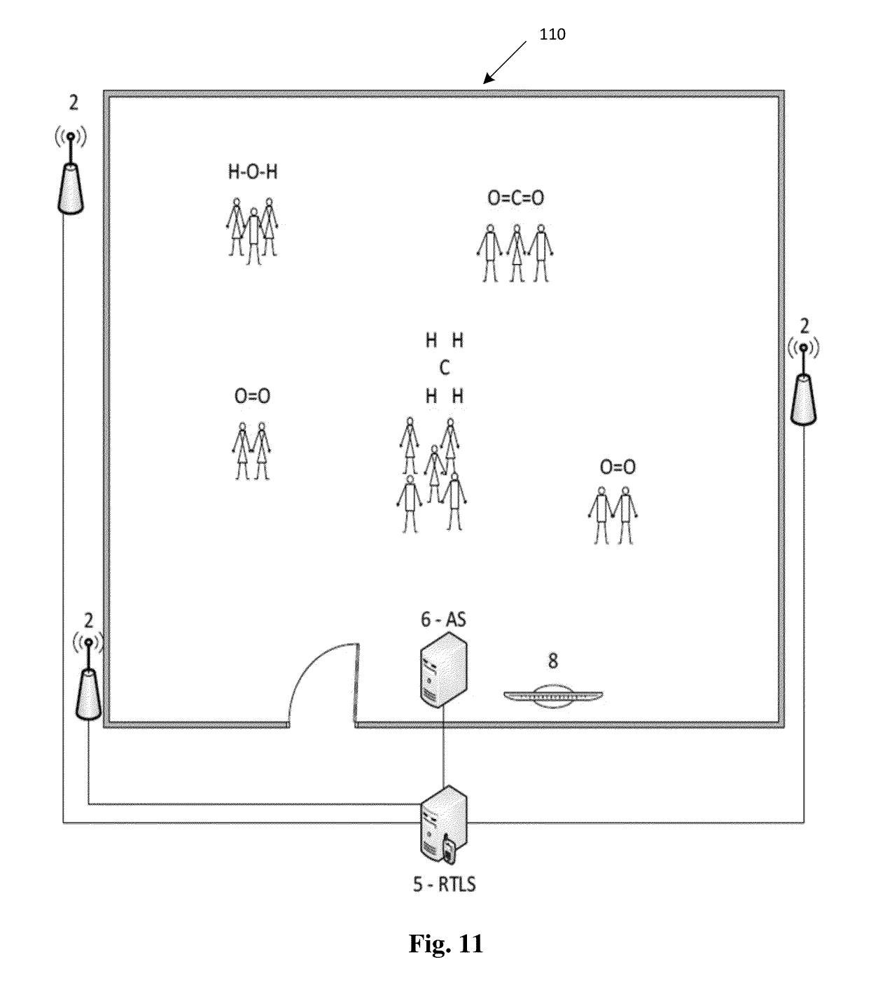

Referring now to FIG. 11, a chemical reaction learning activity system 110 is depicted. In the example chemical reaction learning activity, a group of participants may be assigned to be atoms in a chemical reaction. Each participant may be equipped with a smartwatch 1 and may be able to freely move throughout the classroom. Application server 6 may assign each of the smartwatches 1 to an atom in the chemical reaction (See FIG. 15). The real-time location server 5 may triangulate the smartwatch 1 and may send its location to the application server 6.

The participants may try to simulate chemical bonding according to the chemical reaction being simulated in the activity. A simulation of the chemical bonding may be achieved, for example, by holding hands while the smartwatch 1 could pair to another smartwatch 1, e.g., utilizing the near field communication protocol. The pairing information may be sent to the application server 6 for validation. The display 8 may display the locations of the participants as atoms, and the paired smartwatches 1 as chemical bonds.

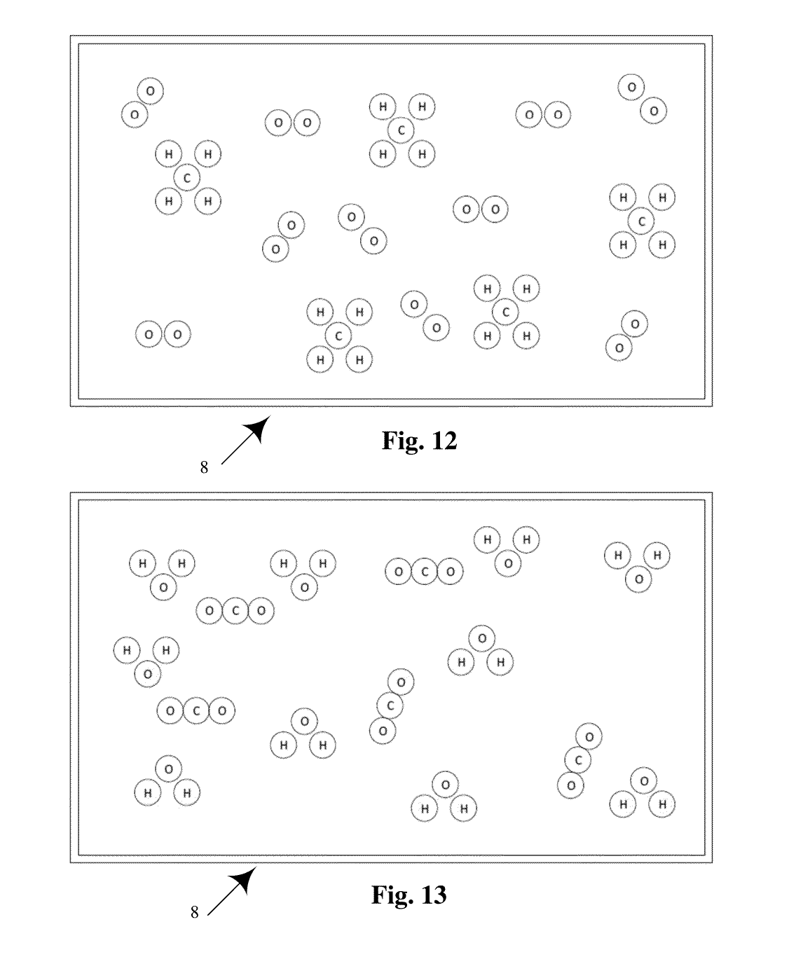

FIG. 12 is a snapshot of the display 8 and illustrates the locations of the participants in the classroom as described in the embodiment of FIG. 7 above. This snapshot illustrates reactants as viewed before a chemical reaction has been started.

FIG. 13 is also a snapshot of the display 8 and illustrates the locations of the participants in the classroom as described in the embodiment of FIG. 7 above. This snapshot illustrates products as viewed after a chemical reaction has been completed.

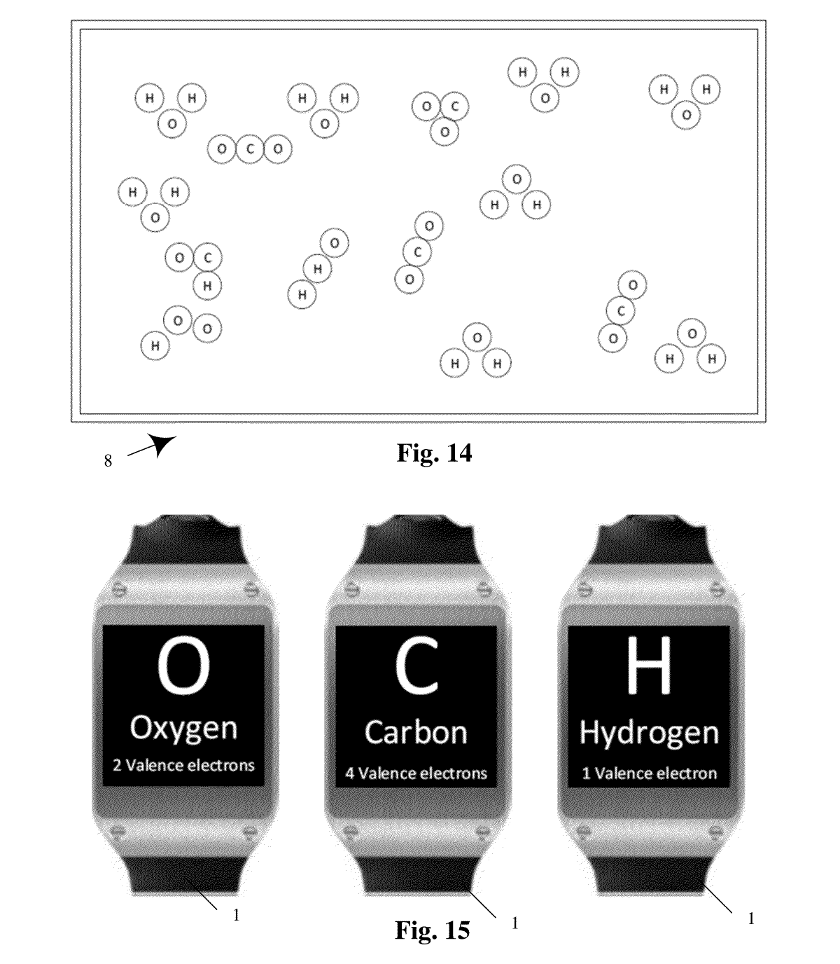

FIG. 14 is a further snapshot of the display 8 and also illustrates the locations of the participants in the classroom as described in the embodiment of FIG. 7 above. This snapshot illustrates common misconceptions in understanding chemical reactions.

FIG. 15 illustrates various snapshots of the smartwatches as described in the embodiment of FIG. 7 above.

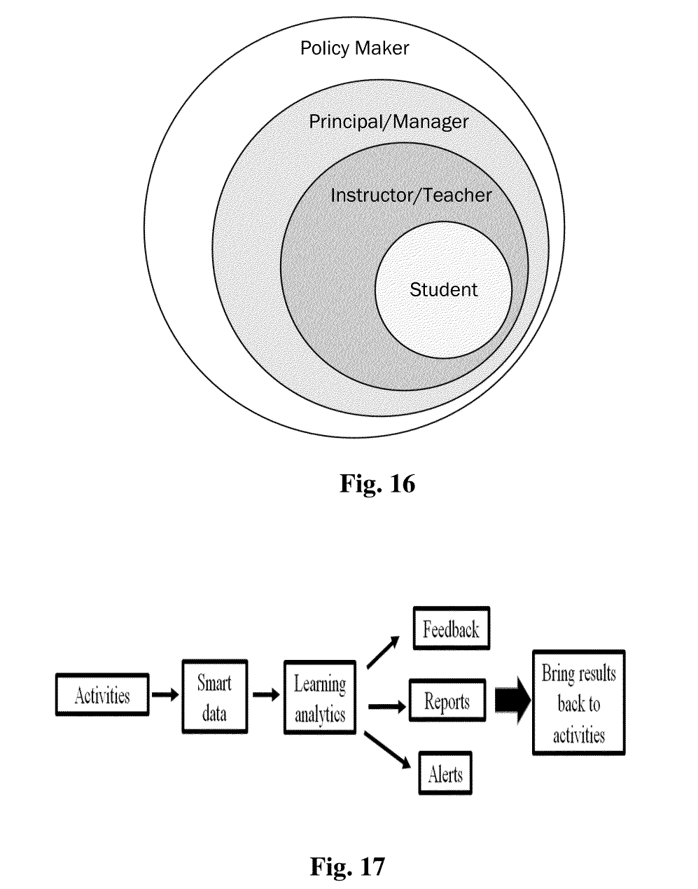

FIG. 16 illustrates the potential uses of the activity data. A principal or school manager may be able to review the performance of participants without stepping foot in the classroom. The principal may be able to review the performance of multiple classrooms to identify core principles that are not understood by the participants. A policy maker may be able to review aggregate data for numerous schools to determine system-wide comprehension. The activity data may also be viewed by the leadership in real-time. The activity data may be made available through internet access as the activity is performed.

FIG. 17 illustrates the potential types of results that can be created using smart data. The smart data, through learning analytics, can provide feedback to teachers or policy makers, provide feature rich reports including statistics or granular results to parents, and provide alerts to teachers, parents, and policy makers regarding the potential downfalls of the learning activity.

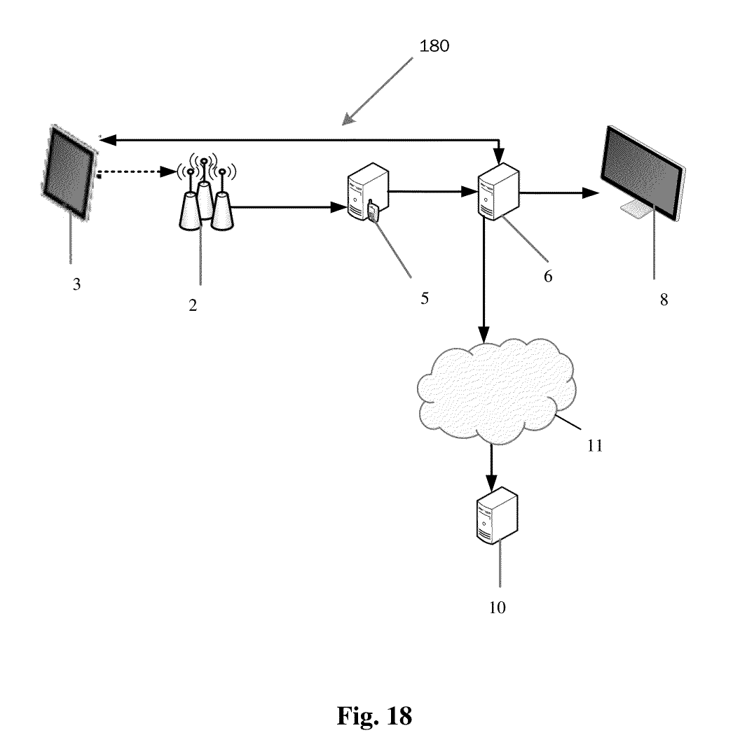

FIG. 18 is a system view of a representative application for a method and learning system 180 including a display 8 and database or data store 10 for using location services to teach concepts according to one embodiment of the present disclosure. The data store 10 can be remotely located in a cloud based storage or other remote storage connected via a WAN.

The learning system 180 includes a data store 10 to house learning activity data from the classroom, school, or school district. The data store 10 may be a structured query language (SQL) database or similar database used to house raw data. The data store 10 may also include a secondary data analytics system as described in FIG. 17.

The above provides a technology-rich learning environment utilizing the availability of personal sensors at the hands of the participants in order to create a new way of integrating learning technologies into their learning environments.

The mobile devices 3 may provide the participants with real-time instruction as they reenact the phenomena. Through these engaging participation-based activities, participants will develop a better understanding of the underlying concepts. Such a novel approach will provide a memorable experience and allow participants to develop a deeper understanding of the core principles being taught. An important advantage of the experience is the availability of instant feedback to both instructors and participants while engaging in the activity.

For participants, this means they have knowledge of what they are doing correctly, and can also make adjustments when necessary to complete the activity. For instructors, instant feedback allows them to monitor participant progress and intervene when necessary. Smart education refers to systems in which information and communication technologies are applied to collect data for the purpose of learning analytics.

Data will be also analyzed to issue other types of reports that include also comparisons between groups of participants (e.g., demographic groups, classes/teachers/schools affiliation, etc.).

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A learning system comprising:
an application server configured to
associate mobile devices with participants such that locations of the participants serve as a life-size model of a learning activity;
track the locations of the mobile devices to determine progress of the participants in performing the learning activity; and
display the locations of the mobile devices on a screen visible to the participants to provide feedback to the participants regarding the progress in performing the learning activity.

2. The learning system of claim 1, further comprising a real-time location server in communication with the application server and configured to:
determine the locations of the mobile devices; and
send the locations of the mobile devices to the application server.

3. The learning system of claim 2, wherein the real-time location server is further configured to determine the locations of the mobile devices periodically according to one or more of: triangulation of the mobile devices, multilateration of the mobile devices, and signal strength of the mobile devices.

4. The learning system of claim 1, wherein the application server is further configured to:
identify a location adjustment to be made by one of the participants to further the progress of the participants in performing the learning activity; and
send information descriptive of the location adjustment to a respective mobile device associated with the one of the participants for display to the participant via the mobile device.

5. The learning system of claim 1, wherein the application server is further configured to:
assign an element of the model to one of the participants; and
send information descriptive of the element to a respective mobile device associated with the one of the participants for display to the participant via the mobile device.

6. The learning system of claim 1, wherein the server is connected to a remote data store over a communications network, and the server is further configured to provide the progress in performing the learning activity over the communications network to the remote data store.

7. The learning system of claim 1, wherein the mobile devices include smartwatches worn by the participants.

8. The learning system of claim 1, wherein each of the mobile devices is associated with an atom of a chemical reaction, and the learning activity includes the participants moving the mobile devices to locations to cause the life-size model to illustrate chemical bonds of the chemical reaction.

9. The learning system of claim 1, wherein each of the mobile devices is associated with an atom of a molecule, and the learning activity includes the participants moving the mobile devices to locations to cause the life-size model to illustrate ordering and spatial distance of the atoms of the molecule.

10. The learning system of claim 1, wherein each of the mobile devices is associated with an element of a sequence, and the learning activity includes the participants moving the mobile devices to locations to cause the life-size model to illustrate the elements in sequence order.

11. An apparatus comprising:
a mobile device configured to
receive, from an application server, information descriptive of an assignment of a participant associated with the mobile device to an element of a life-size model of a learning activity;
display the information to the participant to inform the participant of the element of the life-size model to which the participant is assigned; and
send, to a real-time location server, information indicative of a current location of the mobile device to cause the server to determine progress of the participant in performing the learning activity.

12. The apparatus of claim 11, wherein the mobile device is further configured to:
receive information descriptive of a proposed location adjustment to be made by the participant to further the progress of the participant in performing the learning activity; and
display the proposed location adjustment to the participant.

13. The apparatus of claim 11, wherein the mobile device is one of a smartwatch or a mobile phone.

14. The apparatus of claim 11, wherein the mobile device is associated with an atom of a chemical reaction, and the learning activity includes the participant moving the mobile device to a location to cause the life-size model to illustrate chemical bonds of the chemical reaction.

15. The apparatus of claim 11, wherein the mobile device is associated with an element of a sequence, and the learning activity includes the participant moving the mobile device to a location to cause the life-size model to illustrate the elements in sequence order.

16. A method comprising:
associating mobile devices provided with a locator with a plurality of participants involved in a multi-participant learning activity conducted in a learning environment, so that locations of the participants can be monitored during the learning activity;
at least periodically tracking the locations of the mobile devices and determining the progress of the participants in performing the learning activity using the location information; and
providing feedback to the participants relating to their performance of the learning activity.

17. The method of claim 16, further comprising:
identifying a location adjustment to be made by one of the participants to further the progress of the participants in performing the learning activity; and
sending information descriptive of the location adjustment to a respective mobile device associated with the one of the participants for display to the participant via the mobile device.

18. The method of claim 16, further comprising sending the progress in performing the learning activity over a communications network to a remote data store.

19. The method of claim 16, further comprising displaying the locations of the mobile devices on a monitor within the learning environment visible to the participants to provide feedback to the participants regarding their progress in performing the learning activity.

20. The method of claim 16, further comprising creating reports of the progress of the participants by aggregating the progress from the data store.
